(19) United States
(12) Patent Application Publication
(10) Pub. No.: US 2026/0214544 A1
(43) Pub. Date: Jul. 23, 2026

(54) SYSTEMS AND METHODS FOR ACTIVATION OF REQUIRED RESOURCES FOR WIDE AREA CONDITIONAL HANDOVER

(71) Applicant: Telefonaktiebolaget LM Ericsson (PUBL), Stockholm (SE)

(72) Inventors: Jan CHRISTOFFERSSON, Luleå (SE); Mårten ERICSON, Luleå (SE)

(21) Appl. No.: 19/137,388

(22) PCT Filed: Dec. 16, 2022
(86) PCT No.: PCT/EP2022/086479

§ 371 Date: Jun. 10, 2025

(51) Int. Cl. H04W 36/36

(52) U.S. Cl. CPC H04W 36/362

(57) ABSTRACT

A method (1000) by a target network node (106, 410) associated with a target cell includes receiving (1002), from a first User Equipment, UE (104, 412), a first message indicating a UE identifier, UE ID, of the first UE. The UE ID is associated with a configuration of resources for the first UE, and the resources include required resources and further resources. Based on a required resource of the configuration not being allocated to another UE in the target cell, the target network node transmits (1004), to the first UE, a second message indicating to activate the required resource of the configuration for use by the first UE in the target cell.

### TECHNICAL FIELD

The present disclosure relates, in general, to wireless communications and, more particularly, systems and methods for activation of required resources for Wide Area conditional handover.

### BACKGROUND

A conditional handover feature is standardized in Rel-16. Specifically, Section 9.2.3.4 of 3GPP TS 38.300 defines a Conditional Handover (CHO) as a handover that is executed (run or enacted) by the wireless device when one or more handover execution conditions are met. The wireless device starts evaluating the execution condition(s) upon receiving the CHO configuration and stops evaluating the execution condition(s) once a handover is executed (legacy handover or conditional handover execution). The following principles apply to CHO:
The CHO configuration contains the configuration of CHO candidate cell(s) generated by the candidate gNB(s) and execution condition(s) generated by the source gNB.
An execution (run/enact) condition may consist of one or two trigger condition(s), which may include, for example, RSRP and RSRQ, RSRP and SINR, etc. and can be configured simultaneously for the evaluation of CHO execution condition of a single candidate cell.
The UE executes a normal handover (HO) procedure if it receives a HO command from the network, regardless of the CHO configuration. Thus, the network can override the CHO configuration at any time.
While executing CHO, from the time when the UE starts synchronization with target cell, UE does not monitor source cell.
   CHO is not supported for NG-C based handover in this release of the specification.

Thus, according to 3GPP TS 38.300, a wireless device receives a handover command, which may include a RRCReconfiguration message prepared by a target candidate node and stores the command without applying it as it would have done in legacy handover. Together with the command, the wireless device also receives an associated condition to be monitored. When the condition is fulfilled, the wireless device applies the previously stored handover command, as if the network would have just sent it, instead of first sending a measurement report (that could fail to be transmitted) and then waiting to receive the command (that might fail to be received).

The condition that defines the criteria for applying the stored handover command is based on the quality of the serving cell(s) and neighbor cells. This is somewhat similar to the condition that in previous releases leads the wireless device to transmit a measurement report when the condition is fulfilled. For example, the network can configure the wireless device to transmit a measurement report when the signal quality in a neighbor cell becomes better than the signal quality in the serving cell by an offset amount. The measurement report is a way to indicate to the network that a handover may be needed. In conditional handover, a similar condition can be configured except that, instead of transmitting the measurement report, the wireless device applies the stored message. Sending the handover command when the radio conditions are still favorable reduces the risk of failing the transmission of the measurement report and/or the reception of the handover command. It is also possible to configure two conditions for the wireless device and associate both to the stored command. In this scenario, the command is applied only if both conditions are fulfilled.

On the network side, the serving network node can prepare one or more target “candidate” cells since it's not certain if the wireless device will access a specific target cell. The conditional handover preparation procedure(s) has some similarities with the handover preparation procedure, and the outcome is the creation of a handover command (i.e. an RRCReconfiguration message containing the configuration of the target cell). However, the target node does not expect the wireless device to access the configuration of the target cell immediately and, in some cases, the wireless device will not access the configuration at all.

The best-case scenario is that the wireless device will execute the handover in only one of the prepared candidate target cells. The target network node hosting this candidate target cell needs to inform the source network node that the wireless device successfully performed the handover in the target candidate cell, so that the source network node can cancel the resources reserved by the remaining target candidate network nodes. Additionally, since the time between the handover preparation (and therefore the resource reservation) is unknown, the source network node is also able to release the reserved resources before the wireless device executes the handover.

If multiple target candidate cells need to be prepared to further increase robustness and, in the best case scenario, the wireless device accesses one of the target candidate cells, a set of resources would need to be reserved while the wireless device is monitoring the condition and does not perform the handover. The network, therefore, needs to carefully select the target candidate cell and keep the number of target candidate cells to a reasonable amount, especially in a resource constrained scenario such as, for example, where there is a high load of traffic.

With respect to the forwarding of user plane data during handover, standardization supports two approaches: early data forwarding and late data forwarding. In early data forwarding, data is forwarded during the preparation phase and the main benefit is to enable similar interruption performance as legacy, while increasing robustness. In that solution, the complexity increases with the number of target candidate cells and the time it takes until the handover is actually performed. Late data forwarding is a simpler alternative. Specifically, data is forwarded by the serving node when the wireless device accesses the target cell. The benefit is that the serving network node only forwards data to a single neighbor target network node, even if multiple target network nodes have been prepared. Additionally, the forwarding of the data only begins after the wireless device accesses a target cell, which occurs after the condition is fulfilled.

With respect to control plane handling, as in intra-NR RAN handover, in intra-NR RAN CHO, the preparation and execution phase of the conditional handover procedure is performed without involvement of the 5 GC. For example, preparation messages are directly exchanged between gNBs. The release of the resources at the source gNB during the conditional handover completion phase is triggered by the target gNB.

Another benefit of conditional handover is the fact that the wireless device has handover commands stored for multiple candidate target cells, which reduces interruption time even if a failure occurs. According to the default case (without conditional handover), while the wireless device is monitoring the conditions, a failure may be detected. In Rel-15, the wireless device would perform cell selection (i.e., select a neighboring cell to connect to without the help of the network) and continue with a re-establishment procedure. However, with the introduction of conditional handover, when the same type of failure is detected (e.g. a radio link failure (RLF) or handover failure), the wireless device can prioritize a target candidate cell for which the wireless device has a stored handover command and, instead of performing re-establishment, the wireless device performs a conditional handover, which reduces the interruption time and the signaling over the air interface.

The framework for conditional handover is mainly specified in the Radio Resource Control (RRC) specifications (3GPP TS 38.331 v. 17.0.0) and in Xn interface specifications (3GPP TS 38.423 v. 17.1.0) and is made generic so it can be further enhanced for other types of conditional reconfiguration(s). For example, conditional Primary Secondary Cell (PSCell) change in case of dual-connectivity is also supported in Rel-16, borrowing most of the functionalities defined for conditional handover. A summarized version can be found in the 3GPP TS 38.300 v. 17.0.0.

A new concept is the concept of Wide Area configuration. This concept expands and enhances conditional handover by allowing configurations of a large number of potential candidate target cells and by allowing the wireless device to keep these resources after handover to a new target cell. By this, the signaling of configurations is greatly reduced since it is not repeated after each handover, and robustness is increased since there is no time gap from where the wireless device releases the configurations until the wireless device obtains new configurations.

The main idea with the Wide Area configuration concept is that when a wireless device registers or enters a cell in a defined wide area for the first time or when the procedure is initiated, the cell in which the UE enters the wide area informs the Management Node. The Management Node then sends a list of the RRC configurations for all of the cells belonging to the wide area to the cell.

The Wide Area is typically the set of cells covering large geographical area but can also be a small area such an office with an indoor deployment of a smaller number of cells. It can also be a satellite system covering a certain area where cell changes are common. More examples of how a Wide Area may be constructed or defined is given in the detailed section.

Since the mobile systems employs higher and higher frequencies, the cell range will decrease due to higher propagation loss, worse Power Amplifier (PA) efficiency, extra attenuation due to rain, etc. This can be mitigated to some extent by, for example, techniques such as beamforming, but the cell coverage is still expected to decrease. This means that wireless devices will change cells more often.

Another scenario where the wireless device may change the cell very often is the satellite scenario. Since the satellites are moving quite fast the cell may change very often. FIG. 1 illustrates fast moving satellites. For Low Earth Orbit (LEO) satellites with a moving spot beam with 50 km radius, the spot beam from the satellite at 600 km covers the UE for ~15 s.

Also, networks using only very high frequencies (i.e. “stand-alone”) may experience patchy, or discontinuous, coverage that is rather similar to today's WIFI coverage. FIG. 2 illustrates a system with cells using high frequency that may not always have complete coverage. As a result of the patchy coverage, the wireless device will more frequently experience coverage loss and, thus, RLF. This may work fine anyway as long as the wireless devices can move into coverage and reestablish the connection quickly. However, as it is now, this may be a relatively slow process.

Thus, a challenge with current procedure for RRC configuration of wireless devices is that a relatively large message needs to be transmitted every time a wireless device changes cell. The full configuration of for example RRC reconfiguration or RRC resume requires several MAC Protocol Data Units (PDUs) and, thus, causes large overhead and delay during the procedure, which means longer delays until the wireless device can transmit or receive data. A similar procedure needs to be performed every time the wireless device goes from an idle or inactive state to a connected state.

An inefficiency with CHO is that it requires inter-node signaling between the gNBs for each new CHO configuration. This needs to be done after every cell change (handover). Since the wireless device releases the stored CHO configurations after a successful completion of RRC handover procedure (see FIG. 1 from 3GPP TS 38.300), all of the CHO configurations need to be renewed after every handover. The Wide area conditional handover Wide Area configuration concept has the potential to decrease the signaling for the handover and to increase the reliability. This is achieved by preconfigure the wireless device with certain cell configurations. However, a challenge with the Wide Area configuration is how to manage the reserved resources in the active area of the Wide Area configuration. Since many wireless devices need to reserve resources for the active area in several cells, there may easily be a lack of resources.

Additionally, a reserved resource are not necessarily the same as a used resource. For example, a wireless device may have reserved resources in a cell which it does not use since the wireless device is in a different cell. Since many parameters are limited in the number of possible configurations such as, for example Random Access (RA) preambles that are limited to 64 values in a specific cell, the capacity limit would easily be reached if trying to configure several wireless devices with unique parameters or resources in each cell over an active area.

Other examples of resources that can be limited is PUCCH resources (e.g., for Scheduling Request (SR)), Configured grants, and C-RNTIs. It should be noted that it is possible to initially reserve the same resources for different wireless devices (i.e., the same configuration such as, for example, C-RNTI is configured for several wireless devices) as long as there is no risk of a conflicting use of the resources by multiple wireless devices. In this case, conflicting use refers to the allocation and/or use of a resource by two or more wireless devices operating in the same cell according to a same configuration (e.g., C-RNTI). For example, two or more wireless devices can be assigned with the same (common) C-RNTI in a specific cell as long as only one of these wireless devices is in this cell. However, it is not clear how to ensure that there are no conflicting uses of the C-RNTI and how this should be managed.

### SUMMARY

To improve on existing solutions, disclosed is systems and methods enabling a management node to handle preconfigured resources to reduce the likelihood of conflicting use of a same resource by multiple wireless devices in a cell in a wide area.

According to certain embodiments, a method by a target network node associated with a target cell includes receiving, from a UE, a first message indicating a UE ID of the first UE. The UE ID is associated with a configuration of resources for the first UE, and the resources include required resources and further resources. Based on a required resource of the configuration not being allocated to another UE in the target cell, the target network node transmits, to the first UE, a second message indicating to activate the required resource of the configuration for use by the first UE in the target cell.

According to certain embodiments, a target network node associated with a target cell is adapted to receive, from a UE, a first message indicating a UE ID of the first UE. The UE ID is associated with a configuration of resources for the first UE, and the resources include required resources and further resources. Based on a required resource of the configuration not being allocated to another UE in the target cell, the target network node is adapted to transmit, to the first UE, a second message indicating to activate the required resource of the configuration for use by the first UE in the target cell.

Certain embodiments of the present disclosure may provide one or more technical advantages. For example, certain embodiments may provide a technical advantage of enabling the configurations for cells in an active Wide Area to be reserved in advance while reducing the likelihood of a conflicting use by different wireless devices. Compared to previous techniques and solutions, the reserved configurations or resources can be applied or used much faster than if they were provided by a normal RRC Reconfiguration.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates fast moving satellites;

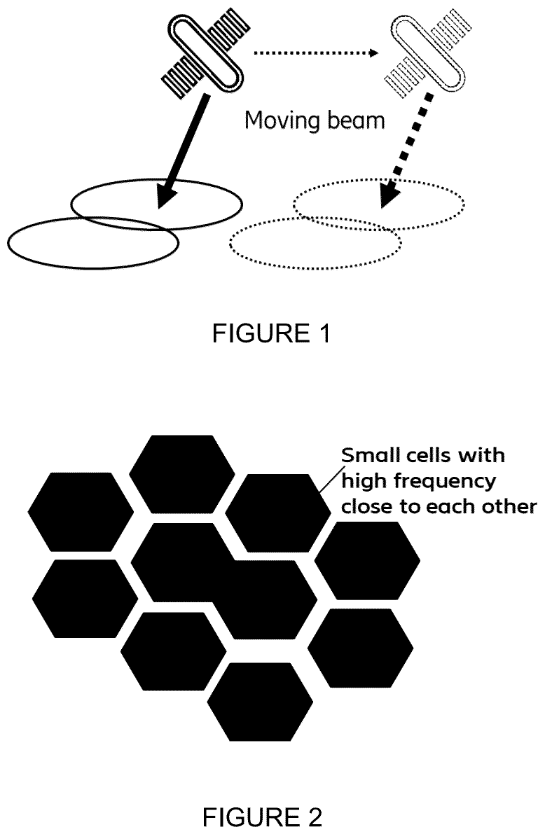

FIG. 2 illustrates a system with cells using high frequency that may not always have complete coverage;

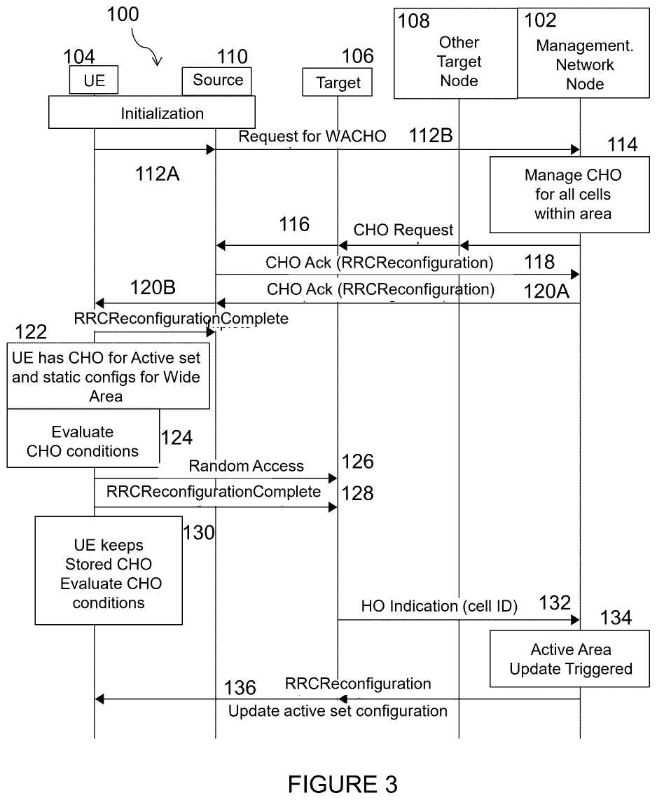

FIG. 3 illustrates a signaling diagram relating to the Wide Area Configuration Concept;

FIG. 4 illustrates a system with cells using high frequency that may not always have complete coverage;

FIG. 6 illustrates a network topology in which a number of UEs share the same resource configuration in cell, according to certain embodiments;

FIG. 7 illustrates an example communication system, according to certain embodiments;

FIG. 8 illustrates an example UE, according to certain embodiments;

FIG. 9 illustrates an example network node, according to certain embodiments;

FIG. 10 illustrates a block diagram of a host, according to certain embodiments;

FIG. 11 illustrates a virtualization environment in which functions implemented by some embodiments may be virtualized, according to certain embodiments;

FIG. 12 illustrates a host communicating via a network node with a UE over a partially wireless connection, according to certain embodiments; and

FIG. 13 illustrates an example method by a target network node, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self-Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

As used herein, Wide Area is a set of neighboring cells which covers a large geographical area. This set is typically large and may contain hundreds of cells. This set is typically rather fixed. The information regarding the configuration of all the cells in this set is not necessarily sent over the Uu interface. Rather, but the information is transmitted only between network nodes. However, at least the cells in the vicinity, e.g. in the active wide area, of the location of a wireless device need to be sent to the wireless device. The Wide Area configuration only includes parameters that can be shared by all wireless devices in the cell. These may include, for example, protocol configurations, timer settings, frequencies, RACH configurations.

As used herein, Active Wide Area includes a subset of neighboring cells in the Wide Area. This set can be a small set of cells covering, for example, an office building. As another example, the Active Wide Area can include the cells a wireless device has visited the last week(s) or the cells that the wireless device is expected to visit within a certain time period. This set can be dynamically changed by the network, for example, in case the wireless device would move to positions where it would risk to handover to a cell not belonging to the Active Wide Area. The information (i.e. configurations of cells belonging to this set) also contain parameters and resources which cannot be shared by several wireless devices in the same cell such as, for example, C-RNTI, SR-PUCCH configurations, and configured grant configurations.

A configuration is, in part, cell specific such as, for example, RACH configurations, common search spaces, and several parameter settings. Other configurations are specific to the wireless device. These may include, for example, C-RNTIs, dedicated search spaces, and PUCCH resources. The UE specific configurations will typically to be reserved in each cell in the active wide area. This will put demands on the number of cells in the Active Wide Area and/or the number of wireless devices that are configured with an active wide area configuration. Some methods to handle this is described below.

For Wide Area configuration, the configurations for cells in the Active Wide Area (or in the potential CHO target cells) needs to be reserved in advance. A management network node covers the Wide Area, which may include multiple cells. The management network node may include a core network node or a source network node that is serving the wireless devices. Since the management network node has knowledge of the positions of the wireless devices, the management network node can configure wireless devices that are not in the same cells with the same resources. For example, wireless devices in different cells may be configured with the same Contention Free Random Access (CFRA), C-RNTI, and/or PUCCH resources.

According to a concept similar to CHO, a UE's stored cell configuration may be referred to as a Special Cell Information Element (SpCell IE). Thus, in certain embodiments, the cell configuration may not be the full Radio Resource Control (RRC) reconfiguration. Another difference from CHO is that the new Special Cell (SpCell) configuration is activated by the new target cell with a Medium Access Control-Control Element (MAC CE) transmission to support faster handover since RRC transmission is slower. One disadvantage of this concept is that it is does not define the area for determining which cells to include in the spCell. Another disadvantage is that it requires inter-node signaling between the cells for each wireless device that is configured with more than one SpCell, which is similar to the conditional HO described above.

Accordingly, certain embodiments described herein enable configuration of the same resource to different wireless devices in a manner that minimizes or reduces the likelihood of a conflicting use by multiple wireless devices. Specifically, for example, several wireless devices are configured with a configuration that is the same or at least partly the same with respect to one or more resources in a target cell. However, according to certain embodiments, these configured resources are not activated until the wireless device performs a HO to the new target cell. In that scenario, a network node associated with the target cell checks to see that a use of the configured resource(s) by the wireless device does not conflict with the resources used by another wireless device currently served in the target cell. If use of the resources by the new wireless device does not conflict with the wireless devices currently served in the target cell, the network node sends an indication to the new wireless device that indicates that the configured resources are activated. However, in the case when it is determined that a use of the resources by the new wireless device will conflict or partly conflict, the network node reconfigures the new wireless device with new resources.

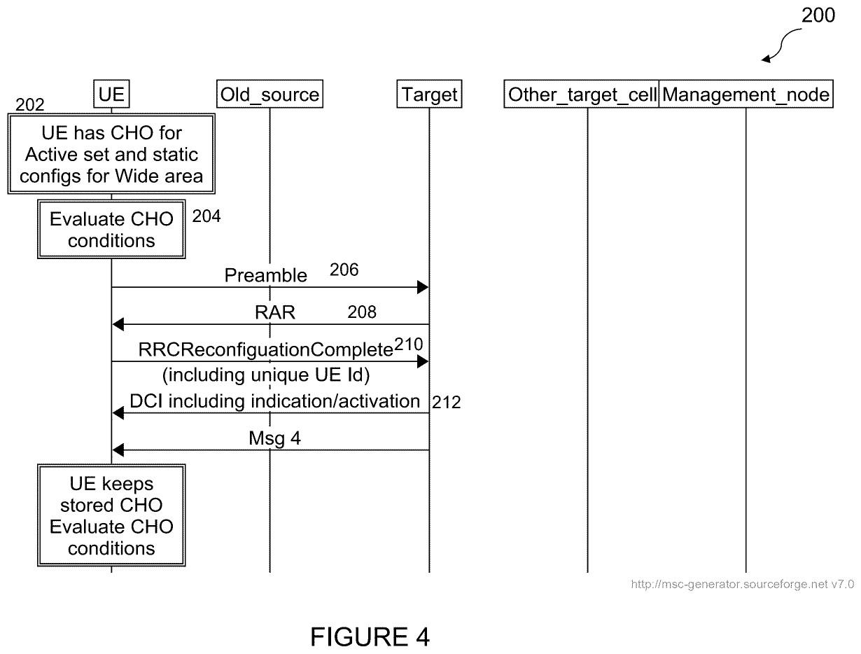

FIG. 3 illustrates example signaling 100 enabling a management network node 102 to monitor the locations of wireless devices, such as UE 104, based on a handover indication from the target node 106 to the management network node 102, according to certain embodiments.

Specifically, at 112A, the UE 104 sends, to the source network node 110, a request for a Wide Area Conditional Handover (WACHO). At 112B, the source network node 110 forwards the request to the management network node 102. The management network node 102 manages the CHO for all cells within the Wide Area, at 114.

At 116, the management node 102 sends a CHO request to at least one of the source network node 110, the target network node 106, or another target node 108. Thereafter the source network node 110 responds with a CHO acknowledgement in a RRCReconfiguration message, at 118.

At 120A, the management network node 102 sends a CHO acknowledgement to the source network node 110, which is then forwarded to the UE 104, at 120B. At 122, the UE 104 returns a RRCReconfigurationComplete.

At 124, the UE 104 evaluates CHO conditions. When a CHO condition is fulfilled, the UE 104 sends a Random Access request to the target network node 106 and a RRCReconfigurationComplete, at 126 and 128, respectively.

At 130, the UE keeps the stored CHO conditions and evaluates CHO conditions.

At 132, the target network node 106 sends a HO indication, which includes a Cell ID. This enables the management network node to discover if two UEs with a same or partly same configuration are at risk of a conflicting use of at least one resource. Monitoring can be on cell level or even more precise such as beam or if UE is approaching cell edge towards a specific target cell. For detailed monitoring the UE can be configured to report when it is approaching the cell border. The Management node monitors UE locations to discover when the capacity limit is reached in a certain area or when there is a likelihood of a conflicting use of at least one resource by two UEs.

At 134, an active Wide Area update is triggered at the management network node 102. Thereafter, the management network node 102 transmits a RRCReconfiguration to update an active set configuration at step 136.

### Resource Activation by Target Cell

As described above, according to certain embodiments, several wireless devices are given the same configuration in the same target cell. As used herein, the term configuration refers to resources that cannot be used by different wireless devices in the same cell at the same time. Thus, configuration relates to dedicated radio resources. The configuration may be for one or several resources such as, for example, RNTIs (e.g., C-RNTI and/or CS-RNTI), PUCCH resources (e.g., SR), CFRA resources (e.g. preambles for random access), Configured Grant resources, and/or SRS (sounding reference signals).

In a particular embodiment, the resources are configured but not initially activated. For example, the wireless device may be configured with a specific resource configuration but may not use the resource configuration until the wireless device receives an indication from a network node associated with a target cell.

In various embodiments, the target network node activates the configuration by different means. As an example, a wireless device is configured with PUCCH resources for SR in a target cell. After a HO to the target cell, the wireless device is not allowed to use the configuration until the wireless device receives a notification that the configuration is activated. This puts the control of ensuring that configurations of wireless devices that are new to a target cell do not conflict with configurations of other wireless devices in the target cell. This may result in faster configuration of the wireless device than compared to conventional HO operations.

Specifically, a network node such as, for example, a gNB, may identify a wireless device and a configuration that is assigned to the wireless device. In a particular embodiment, for example, a wireless device that is being handed over to the cell served by the network node may be associated with a unique UE identifier. In a particular embodiment, for example, the content of a RRCReconfigurationComplete message sent from the wireless device is modified to carry a UE identifier, which may be unique to the UE such that no other UEs in the target cell are identified by the UE identifier. This UE identifier enables a network node such as, for example, a gNB, to be able to uniquely identify the UE. As used herein, the term UE identifier is used to refer to something other than a configured C-RNTI since a C-RNTI is not unique and can be assigned to or configured for several UEs.

In a particular embodiment, the network node may use a mapping or table that indicates an association between the UE identifier of the wireless device and a configuration. Based on the mapping, table or other association, the network node is able to determine if another wireless device is using the configuration.

If the configuration is already in use in the cell, the network node sends a message to the wireless device to reconfigure the wireless device with another configuration. In a particular embodiment, for example, the network node may transmit, to the wireless device, an indication of whether the UE can activate all or parts of the already configured resources.

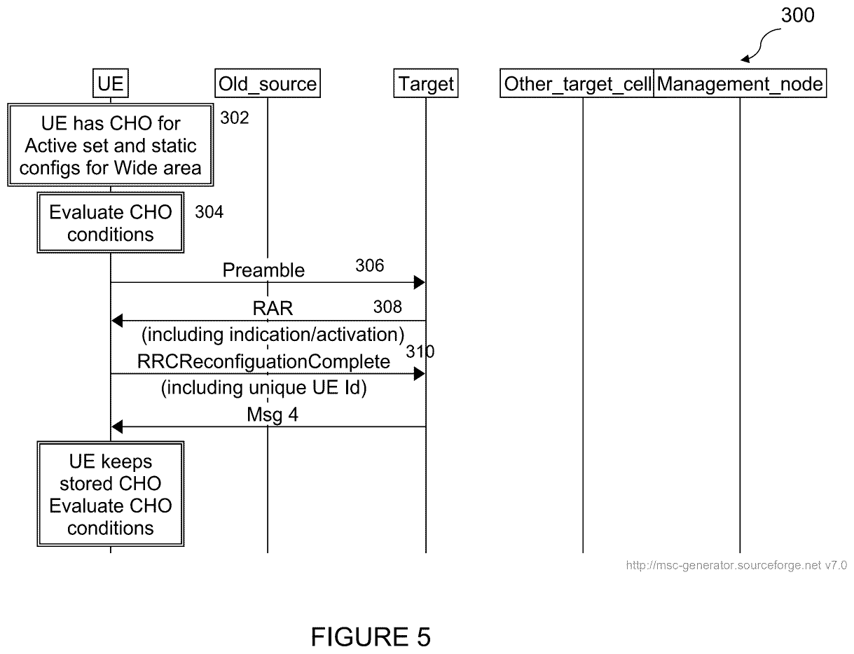

In a particular embodiment, the indication is carried in a DCI. For example, FIG. 4 illustrates example signaling 200 for activation of configured resources using DCI, according to certain embodiments.

Specifically, at 202, a UE has a CHO for an active set and static configurations for a wide area. The UE evaluates CHO conditions and determines to execute (perform, or run) a CHO, at 204. At 206, the UE transmits a preamble to the target network node. Thereafter, the target network node transmits a RAR, at 208.

At 210, the UE transmits a RRCReconfigurationComplete, which includes the unique UE identifier and indicates that the UE is being handed over to the target cell. The target network node responds, at 212, with DCI comprising an indication or other activation of resources for the target cell.

In a particular embodiment, the DCI indicates that all of the shared resources can be used by the UE. In another particular embodiment, the DCI indicates a subset of resources that cannot be used and/or a subset of resources that can be used. This has the advantage that some resources, e.g. C-RNTI and configured grant, can be used directly while other parameters such as, CFRA and SR configurations, cannot be used.

Since a C-RNTI of a UE may collide with a C-RNTI of another UE in the cell, the DCI cannot be identified by the C-RNTI. As such, according to certain embodiments, a network node creates a TC-RNTI that is unique for a particular UE. The unique TC-RNTI may be transmitted in a RAR. Thereafter, the UE uses the TC-RNTI to determine whether received DCI is intended for the UE.

In still other embodiments, the indication of whether the wireless device can activate all or parts of the already configured resources is carried by the RAR in the random access procedure leading up to the transmission of the RRCReconfigurationComplete. In this scenario, the wireless device uses CFRA in order for the network node to be able to identify the wireless device before receiving the RRCReconfigurationComplete message. FIG. 5 illustrates example signaling 300 for activation of configured resources using CFRA and RAR, according to certain embodiments.

Specifically, at 302, a UE has a CHO for an active set and static configurations for a wide area. The UE evaluates CHO conditions and determines to execute a CHO, at 304. At 306, the UE transmits a preamble to the target network node. Thereafter, at 308, the target network node transmits a RAR, which includes an indication and/or activation of one or more configured resources for the target cell.

At 310, the UE transmits a RRCReconfigurationComplete, which includes the unique UE identifier and indicates that the UE is being handed over to the target cell. The target network node responds, at 312, with a Msg 4.

This method requires that the CFRA resources for the target cell are unique for the wireless device. To ensure this, it may be required that the configuration is managed by a management node that has access to all UEs locations within the Wide Area to ensure that the use of the CFRA resources associated with the cell do not conflict. To exemplify this, wireless devices located in both cell A and cell B must have unique CFRA resources to cell C, i.e. the CFRA resources for accessing a specific cell must be unique for all wireless devices in the cells neighboring cells.

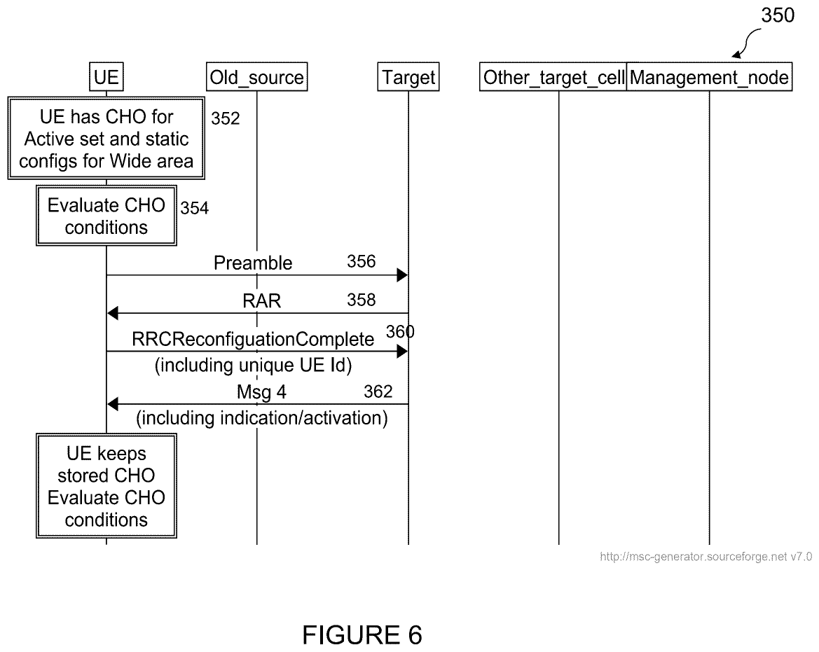

In still other example embodiments, the indication of whether the wireless device can activate all or parts of the already configured resources is carried by Msg4 in the random access after the transmission of the RRCReconfigurationComplete. FIG. 6 illustrates example signaling 350 for activation of configured resources using Msg4, according to certain embodiments.

Specifically, at 352, a UE has a CHO for an active set and static configurations for a wide area. The UE evaluates CHO conditions and determines to execute a CHO, at 354. At 356, the UE transmits a preamble to the target network node. Thereafter, at 308, the target network node transmits a RAR.

At 360, the UE transmits a RRCReconfigurationComplete, which includes a unique UE identifier and indicates that the UE is being handed over to the target cell. The target network node responds, at 362, with a Msg 4, which includes an indication and/or activation of one or more configured resources for the target cell.

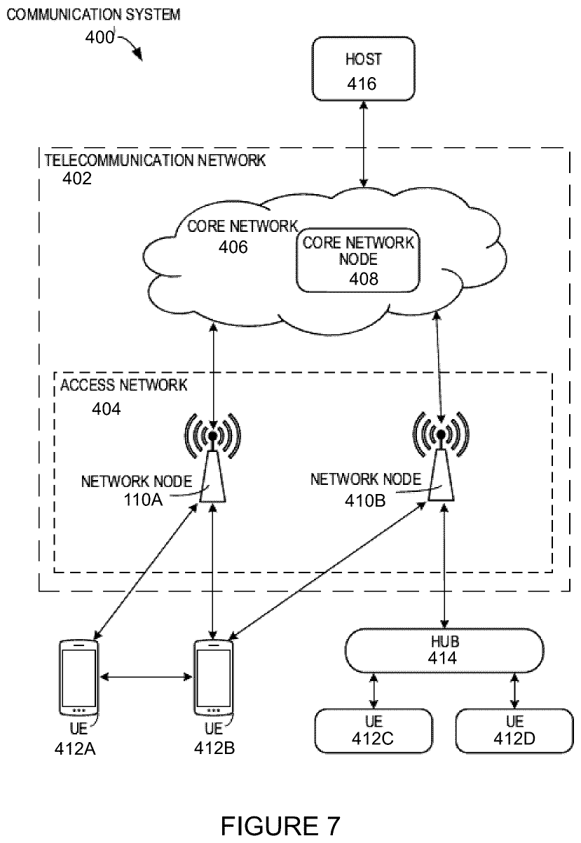

In this case, the wireless device is identified by the unique UE identifier in the RRCReconfigurationComplete message. This method will also work even if the new wireless device uses a conflicting C-RNTI. FIG. 7 shows an example of a communication system 400 in accordance with some embodiments. In the example, the communication system 400 includes a telecommunication network 402 that includes an access network 404, such as a radio access network (RAN), and a core network 406, which includes one or more core network nodes 408. The access network 404 includes one or more access network nodes, such as network nodes 410a and 410b (one or more of which may be generally referred to as network nodes 410), or any other similar 3^{rd} Generation Partnership Project (3GPP) access node or non-3GPP access point. The network nodes 410 facilitate direct or indirect connection of user equipment (UE), such as by connecting UEs 412a, 412b, 412c, and 412d (one or more of which may be generally referred to as UEs 412) to the core network 406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 400 may include any number of wired or wireless networks, network nodes, UEs, and/or any other components or systems that may facilitate or participate in the communication of data and/or signals whether via wired or wireless connections. The communication system 400 may include and/or interface with any type of communication, telecommunication, data, cellular, radio network, and/or other similar type of system.

The UEs 412 may be any of a wide variety of communication devices, including wireless devices arranged, configured, and/or operable to communicate wirelessly with the network nodes 410 and other communication devices. Similarly, the network nodes 410 are arranged, capable, configured, and/or operable to communicate directly or indirectly with the UEs 412 and/or with other network nodes or equipment in the telecommunication network 402 to enable and/or provide network access, such as wireless network access, and/or to perform other functions, such as administration in the telecommunication network 402.

In the depicted example, the core network 406 connects the network nodes 410 to one or more hosts, such as host 416. These connections may be direct or indirect via one or more intermediary networks or devices. In other examples, network nodes may be directly coupled to hosts. The core network 406 includes one more core network nodes (e.g., core network node 408) that are structured with hardware and software components. Features of these components may be substantially similar to those described with respect to the UEs, network nodes, and/or hosts, such that the descriptions thereof are generally applicable to the corresponding components of the core network node 408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 416 may be under the ownership or control of a service provider other than an operator or provider of the access network 404 and/or the telecommunication network 402 and may be operated by the service provider or on behalf of the service provider. The host 416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 400 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 402 is a cellular network that implements 3GPP standardized features. Accordingly, the telecommunications network 402 may support network slicing to provide different logical networks to different devices that are connected to the telecommunication network 402. For example, the telecommunications network 402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 412 are configured to transmit and/or receive information without direct human interaction. For instance, a UE may be designed to transmit information to the access network 404 on a predetermined schedule, when triggered by an internal or external event, or in response to requests from the access network 404. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 414 communicates with the access network 404 to facilitate indirect communication between one or more UEs (e.g., UE 412c and/or 412d) and network nodes (e.g., network node 410b). In some examples, the hub 414 may be a controller, router, content source and analytics, or any of the other communication devices described herein regarding UEs. For example, the hub 414 may be a broadband router enabling access to the core network 406 for the UEs. As another example, the hub 414 may be a controller that sends commands or instructions to one or more actuators in the UEs. Commands or instructions may be received from the UEs, network nodes 410, or by executable code, script, process, or other instructions in the hub 414. As another example, the hub 414 may be a data collector that acts as temporary storage for UE data and, in some embodiments, may perform analysis or other processing of the data. As another example, the hub 414 may be a content source. For example, for a UE that is a VR headset, display, loudspeaker or other media delivery device, the hub 414 may retrieve VR assets, video, audio, or other media or data related to sensory information via a network node, which the hub 414 then provides to the UE either directly, after performing local processing, and/or after adding additional local content. In still another example, the hub 414 acts as a proxy server or orchestrator for the UEs, in particular in if one or more of the UEs are low energy IoT devices.

The hub 414 may have a constant/persistent or intermittent connection to the network node 410b. The hub 414 may also allow for a different communication scheme and/or schedule between the hub 414 and UEs (e.g., UE 412c and/or 412d), and between the hub 414 and the core network 406. In other examples, the hub 414 is connected to the core network 406 and/or one or more UEs via a wired connection. Moreover, the hub 414 may be configured to connect to an M2M service provider over the access network 404 and/or to another UE over a direct connection. In some scenarios, UEs may establish a wireless connection with the network nodes 410 while still connected via the hub 414 via a wired or wireless connection. In some embodiments, the hub 414 may be a dedicated hub-that is, a hub whose primary function is to route communications to/from the UEs from/to the network node 410b. In other embodiments, the hub 414 may be a non-dedicated hub-that is, a device which is capable of operating to route communications between the UEs and network node 410b, but which is additionally capable of operating as a communication start and/or end point for certain data channels.

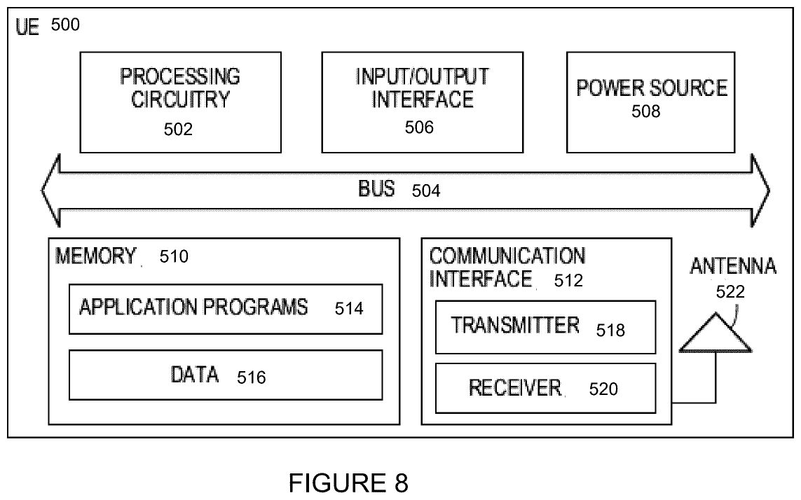

FIG. 8 shows a UE 500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, play back appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 500 includes processing circuitry 502 that is operatively coupled via a bus 504 to an input/output interface 506, a power source 508, a memory 510, a communication interface 512, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 502 is configured to process instructions and data and may be configured to implement any sequential state machine operative to execute instructions stored as machine-readable computer programs in the memory 510. The processing circuitry 502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 502 may include multiple central processing units (CPUs).

In the example, the input/output interface 506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 508 is structured as a battery or battery pack. Other types of power sources, such as an external power source (e.g., an electricity outlet), photovoltaic device, or power cell, may be used. The power source 508 may further include power circuitry for delivering power from the power source 508 itself, and/or an external power source, to the various parts of the UE 500 via input circuitry or an interface such as an electrical power cable. Delivering power may be, for example, for charging of the power source 508. Power circuitry may perform any formatting, converting, or other modification to the power from the power source 508 to make the power suitable for the respective components of the UE 500 to which power is supplied.

The memory 510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 510 includes one or more application programs 514, such as an operating system, web browser application, a widget, gadget engine, or other application, and corresponding data 516. The memory 510 may store, for use by the UE 500, any of a variety of various operating systems or combinations of operating systems.

The memory 510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 510 may allow the UE 500 to access instructions, application programs and the like, stored on transitory or non-transitory memory media, to off-load data, or to upload data. An article of manufacture, such as one utilizing a communication system may be tangibly embodied as or in the memory 510, which may be or comprise a device-readable storage medium.

The processing circuitry 502 may be configured to communicate with an access network or other network using the communication interface 512. The communication interface 512 may comprise one or more communication subsystems and may include or be communicatively coupled to an antenna 522. The communication interface 512 may include one or more transceivers used to communicate, such as by communicating with one or more remote transceivers of another device capable of wireless communication (e.g., another UE or a network node in an access network). Each transceiver may include a transmitter 518 and/or a receiver 520 appropriate to provide network communications (e.g., optical, electrical, frequency allocations, and so forth). Moreover, the transmitter 518 and receiver 520 may be coupled to one or more antennas (e.g., antenna 522) and may share circuit components, software, or firmware, or alternatively be implemented separately.

In the illustrated embodiment, communication functions of the communication interface 512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 500 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

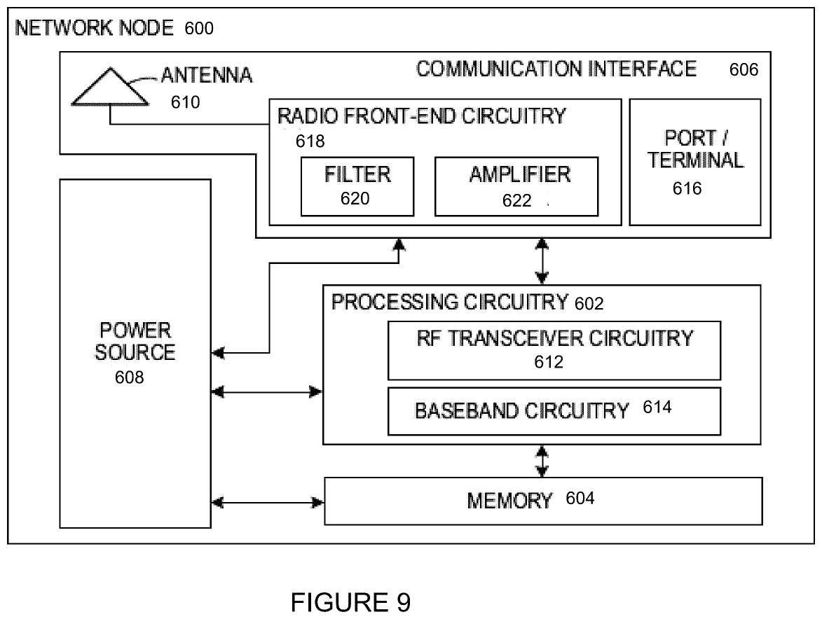

FIG. 9 shows a network node 600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 600 includes a processing circuitry 602, a memory 604, a communication interface 606, and a power source 608. The network node 600 may be composed of multiple physically separate components (e.g., a NodeB component and a RNC component, or a BTS component and a BSC component, etc.), which may each have their own respective components. In certain scenarios in which the network node 600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 600 may be configured to support multiple radio access technologies (RATs). In such embodiments, some components may be duplicated (e.g., separate memory 604 for different RATs) and some components may be reused (e.g., a same antenna 610 may be shared by different RATs). The network node 600 may also include multiple sets of the various illustrated components for different wireless technologies integrated into network node 600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 600.

The processing circuitry 602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 600 components, such as the memory 604, to provide network node 600 functionality.

In some embodiments, the processing circuitry 602 includes a system on a chip (SOC). In some embodiments, the processing circuitry 602 includes one or more of radio frequency (RF) transceiver circuitry 612 and baseband processing circuitry 614. In some embodiments, the radio frequency (RF) transceiver circuitry 612 and the baseband processing circuitry 614 may be on separate chips (or sets of chips), boards, or units, such as radio units and digital units. In alternative embodiments, part or all of RF transceiver circuitry 612 and baseband processing circuitry 614 may be on the same chip or set of chips, boards, or units.

The memory 604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 602. The memory 604 may store any suitable instructions, data, or information, including a computer program, software, an application including one or more of logic, rules, code, tables, and/or other instructions capable of being executed by the processing circuitry 602 and utilized by the network node 600. The memory 604 may be used to store any calculations made by the processing circuitry 602 and/or any data received via the communication interface 606. In some embodiments, the processing circuitry 602 and memory 604 is integrated.

The communication interface 606 is used in wired or wireless communication of signaling and/or data between a network node, access network, and/or UE. As illustrated, the communication interface 606 comprises port(s)/terminal(s) 616 to send and receive data, for example to and from a network over a wired connection. The communication interface 606 also includes radio front-end circuitry 618 that may be coupled to, or in certain embodiments a part of, the antenna 610. Radio front-end circuitry 618 comprises filters 620 and amplifiers 622. The radio front-end circuitry 618 may be connected to an antenna 610 and processing circuitry 602. The radio front-end circuitry may be configured to condition signals communicated between antenna 610 and processing circuitry 602. The radio front-end circuitry 618 may receive digital data that is to be sent out to other network nodes or UEs via a wireless connection. The radio front-end circuitry 618 may convert the digital data into a radio signal having the appropriate channel and bandwidth parameters using a combination of filters 620 and/or amplifiers 622. The radio signal may then be transmitted via the antenna 610. Similarly, when receiving data, the antenna 610 may collect radio signals which are then converted into digital data by the radio front-end circuitry 618. The digital data may be passed to the processing circuitry 602. In other embodiments, the communication interface may comprise different components and/or different combinations of components.

In certain alternative embodiments, the network node 600 does not include separate radio front-end circuitry 618, instead, the processing circuitry 602 includes radio front-end circuitry and is connected to the antenna 610. Similarly, in some embodiments, all, or some of the RF transceiver circuitry 612 is part of the communication interface 606. In still other embodiments, the communication interface 606 includes one or more ports or terminals 616, the radio front-end circuitry 618, and the RF transceiver circuitry 612, as part of a radio unit (not shown), and the communication interface 606 communicates with the baseband processing circuitry 614, which is part of a digital unit (not shown).

The antenna 610 may include one or more antennas, or antenna arrays, configured to send and/or receive wireless signals. The antenna 610 may be coupled to the radio front-end circuitry 618 and may be any type of antenna capable of transmitting and receiving data and/or signals wirelessly. In certain embodiments, the antenna 610 is separate from the network node 600 and connectable to the network node 600 through an interface or port.

The antenna 610, communication interface 606, and/or the processing circuitry 602 may be configured to perform any receiving operations and/or certain obtaining operations described herein as being performed by the network node. Any information, data and/or signals may be received from a UE, another network node and/or any other network equipment. Similarly, the antenna 610, the communication interface 606, and/or the processing circuitry 602 may be configured to perform any transmitting operations described herein as being performed by the network node. Any information, data and/or signals may be transmitted to a UE, another network node and/or any other network equipment.

The power source 608 provides power to the various components of network node 600 in a form suitable for the respective components (e.g., at a voltage and current level needed for each respective component). The power source 608 may further comprise, or be coupled to, power management circuitry to supply the components of the network node 600 with power for performing the functionality described herein. For example, the network node 600 may be connectable to an external power source (e.g., the power grid, an electricity outlet) via an input circuitry or interface such as an electrical cable, whereby the external power source supplies power to power circuitry of the power source 608. As a further example, the power source 608 may comprise a source of power in the form of a battery or battery pack which is connected to, or integrated in, power circuitry. The battery may provide backup power should the external power source fail.

Embodiments of the network node 600 may include additional components beyond those shown in FIG. 9 for providing certain aspects of the network node's functionality, including any of the functionality described herein and/or any functionality necessary to support the subject matter described herein. For example, the network node 600 may include user interface equipment to allow input of information into the network node 600 and to allow output of information from the network node 600. This may allow a user to perform diagnostic, maintenance, repair, and other administrative functions for the network node 600.

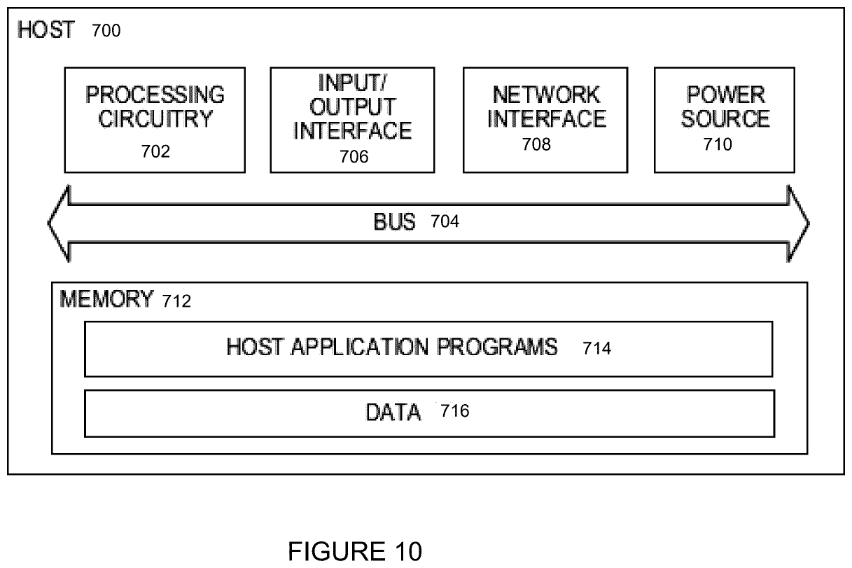

FIG. 10 is a block diagram of a host 700, which may be an embodiment of the host 416 of FIG. 7, in accordance with various aspects described herein. As used herein, the host 700 may be or comprise various combinations hardware and/or software, including a standalone server, a blade server, a cloud-implemented server, a distributed server, a virtual machine, container, or processing resources in a server farm. The host 700 may provide one or more services to one or more UEs.

The host 700 includes processing circuitry 702 that is operatively coupled via a bus 704 to an input/output interface 706, a network interface 708, a power source 710, and a memory 712. Other components may be included in other embodiments. Features of these components may be substantially similar to those described with respect to the devices of previous figures, such as FIGS. 5 and 6, such that the descriptions thereof are generally applicable to the corresponding components of host 700.

The memory 712 may include one or more computer programs including one or more host application programs 714 and data 716, which may include user data, e.g., data generated by a UE for the host 700 or data generated by the host 700 for a UE. Embodiments of the host 700 may utilize only a subset or all of the components shown. The host application programs 714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 714 may also provide for user authentication and licensing checks and may periodically report health, routes, and content availability to a central node, such as a device in or on the edge of a core network. Accordingly, the host 700 may select and/or indicate a different host for over-the-top services for a UE. The host application programs 714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

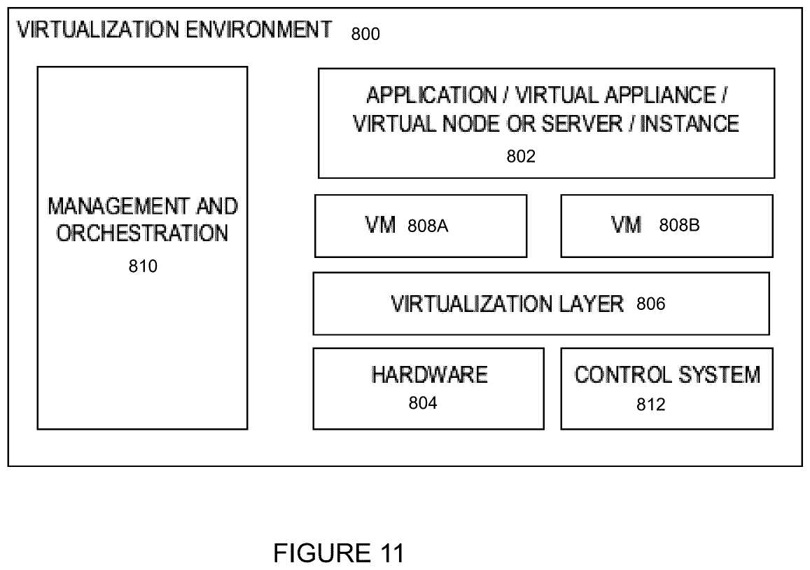

FIG. 11 is a block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 806 (also referred to as hypervisors or virtual machine monitors (VMMs)), provide VMs 808a and 808b (one or more of which may be generally referred to as VMs 808), and/or perform any of the functions, features and/or benefits described in relation with some embodiments described herein. The virtualization layer 806 may present a virtual operating platform that appears like networking hardware to the VMs 808.

The VMs 808 comprise virtual processing, virtual memory, virtual networking or interface and virtual storage, and may be run by a corresponding virtualization layer 806. Different embodiments of the instance of a virtual appliance 802 may be implemented on one or more of VMs 808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 808 may be a software implementation of a physical machine that runs programs as if they were executing on a physical, non-virtualized machine. Each of the VMs 808, and that part of hardware 804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 808 on top of the hardware 804 and corresponds to the application 802.

Hardware 804 may be implemented in a standalone network node with generic or specific components. Hardware 804 may implement some functions via virtualization. Alternatively, hardware 804 may be part of a larger cluster of hardware (e.g. such as in a data center or CPE) where many hardware nodes work together and are managed via management and orchestration 810, which, among others, oversees lifecycle management of applications 802. In some embodiments, hardware 804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 812 which may alternatively be used for communication between hardware nodes and radio units.

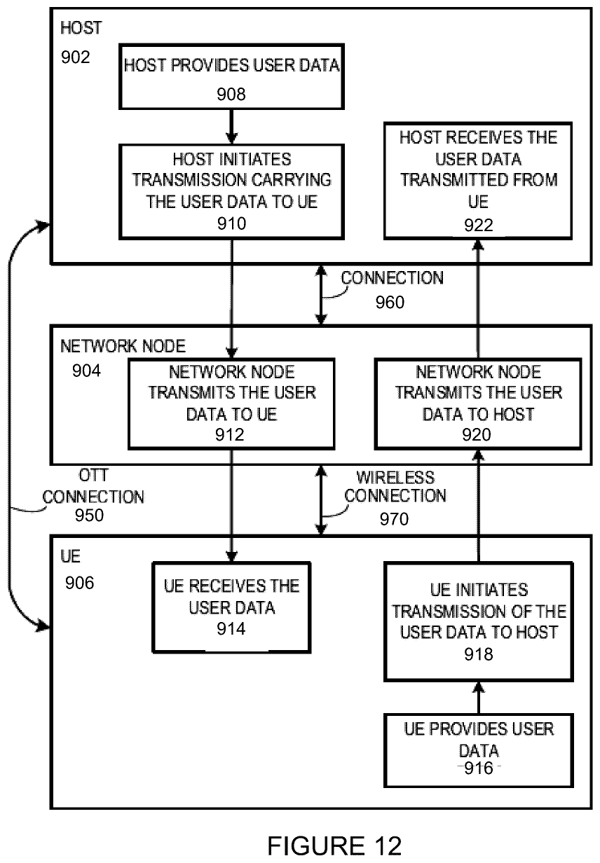

FIG. 12 shows a communication diagram of a host 902 communicating via a network node 904 with a UE 906 over a partially wireless connection in accordance with some embodiments. Example implementations, in accordance with various embodiments, of the UE (such as a UE 412a of FIG. 7 and/or UE 500 of FIG. 8), network node (such as network node 410a of FIG. 7 and/or network node 600 of FIG. 9), and host (such as host 416 of FIG. 7 and/or host 700 of FIG. 10) discussed in the preceding paragraphs will now be described with reference to FIG. 12.

Like host 700, embodiments of host 902 include hardware, such as a communication interface, processing circuitry, and memory. The host 902 also includes software, which is stored in or accessible by the host 902 and executable by the processing circuitry. The software includes a host application that may be operable to provide a service to a remote user, such as the UE 906 connecting via an over-the-top (OTT) connection 950 extending between the UE 906 and host 902. In providing the service to the remote user, a host application may provide user data which is transmitted using the OTT connection 950.

The network node 904 includes hardware enabling it to communicate with the host 902 and UE 906. The connection 960 may be direct or pass through a core network (like core network 406 of FIG. 7) and/or one or more other intermediate networks, such as one or more public, private, or hosted networks. For example, an intermediate network may be a backbone network or the Internet.

The UE 906 includes hardware and software, which is stored in or accessible by UE 906 and executable by the UE's processing circuitry. The software includes a client application, such as a web browser or operator-specific “app” that may be operable to provide a service to a human or non-human user via UE 906 with the support of the host 902. In the host 902, an executing host application may communicate with the executing client application via the OTT connection 950 terminating at the UE 906 and host 902. In providing the service to the user, the UE's client application may receive request data from the host's host application and provide user data in response to the request data. The OTT connection 950 may transfer both the request data and the user data. The UE's client application may interact with the user to generate the user data that it provides to the host application through the OTT connection 950.

The OTT connection 950 may extend via a connection 960 between the host 902 and the network node 904 and via a wireless connection 970 between the network node 904 and the UE 906 to provide the connection between the host 902 and the UE 906. The connection 960 and wireless connection 970, over which the OTT connection 950 may be provided, have been drawn abstractly to illustrate the communication between the host 902 and the UE 906 via the network node 904, without explicit reference to any intermediary devices and the precise routing of messages via these devices.

As an example of transmitting data via the OTT connection 950, in step 908, the host 902 provides user data, which may be performed by executing a host application. In some embodiments, the user data is associated with a particular human user interacting with the UE 906. In other embodiments, the user data is associated with a UE 906 that shares data with the host 902 without explicit human interaction. In step 910, the host 902 initiates a transmission carrying the user data towards the UE 906. The host 902 may initiate the transmission responsive to a request transmitted by the UE 906. The request may be caused by human interaction with the UE 906 or by operation of the client application executing on the UE 906. The transmission may pass via the network node 904, in accordance with the teachings of the embodiments described throughout this disclosure. Accordingly, in step 912, the network node 904 transmits to the UE 906 the user data that was carried in the transmission that the host 902 initiated, in accordance with the teachings of the embodiments described throughout this disclosure. In step 914, the UE 906 receives the user data carried in the transmission, which may be performed by a client application executed on the UE 906 associated with the host application executed by the host 902.

In some examples, the UE 906 executes a client application which provides user data to the host 902. The user data may be provided in reaction or response to the data received from the host 902. Accordingly, in step 916, the UE 906 may provide user data, which may be performed by executing the client application. In providing the user data, the client application may further consider user input received from the user via an input/output interface of the UE 906. Regardless of the specific manner in which the user data was provided, the UE 906 initiates, in step 918, transmission of the user data towards the host 902 via the network node 904. In step 920, in accordance with the teachings of the embodiments described throughout this disclosure, the network node 904 receives user data from the UE 906 and initiates transmission of the received user data towards the host 902. In step 922, the host 902 receives the user data carried in the transmission initiated by the UE 906.

One or more of the various embodiments improve the performance of OTT services provided to the UE 906 using the OTT connection 950, in which the wireless connection 970 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 902. As another example, the host 902 may process audio and video data which may have been retrieved from a UE for use in creating maps. As another example, the host 902 may collect and analyze real-time data to assist in controlling vehicle congestion (e.g., controlling traffic lights). As another example, the host 902 may store surveillance video uploaded by a UE. As another example, the host 902 may store or control access to media content such as video, audio, VR or AR which it can broadcast, multicast or unicast to UEs. As other examples, the host 902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection 950 between the host 902 and UE 906, in response to variations in the measurement results. The measurement procedure and/or the network functionality for reconfiguring the OTT connection may be implemented in software and hardware of the host 902 and/or UE 906. In some embodiments, sensors (not shown) may be deployed in or in association with other devices through which the OTT connection 950 passes; the sensors may participate in the measurement procedure by supplying values of the monitored quantities exemplified above or supplying values of other physical quantities from which software may compute or estimate the monitored quantities. The reconfiguring of the OTT connection 950 may include message format, retransmission settings, preferred routing etc.; the reconfiguring need not directly alter the operation of the network node 904. Such procedures and functionalities may be known and practiced in the art. In certain embodiments, measurements may involve proprietary UE signaling that facilitates measurements of throughput, propagation times, latency, and the like, by the host 902. The measurements may be implemented in that software causes messages to be transmitted, in particular empty or ‘dummy’ messages, using the OTT connection 950 while monitoring propagation times, errors, etc.

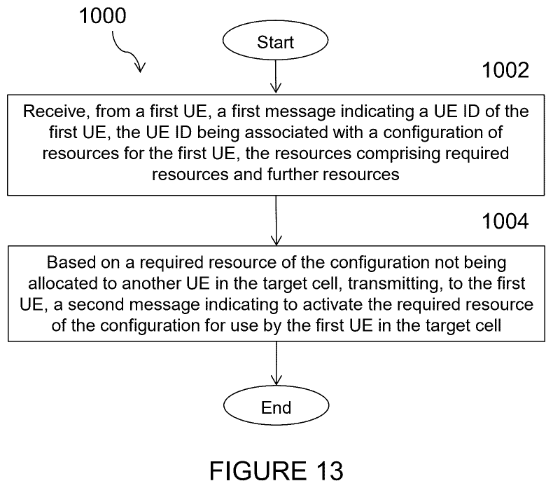

FIG. 13 illustrates a method 1000 by a target network node 106 associated with a target cell, according to certain embodiments. At step 1002, the target network node 106 receives, from a first UE 104, a first message indicating a UE ID of the first UE. The UE ID is associated with a configuration of resources for the first UE 104, and the resources include both required resources and further resources. Based on a required resource of the configuration not being allocated to another UE in the target cell, the target network node 106 transmits, to the first UE 104, a second message indicating to activate the required resource of the configuration for use by the first UE 104 in the target cell.

As used herein, a required resource includes a resource that cannot be shared and, thus, is non-sharable by the UEs. Thus, only one UE can use a required resource in a target cell. As used herein, the terms required resource, critical resource, dedicated resource, dedicated radio resource, configuration, and/or parameters may be used interchangeably. Conversely, other resources may include resources that can be shared and, thus, are shareable by the UEs.

In a particular embodiment, the UE ID is unique to the first UE, as distinct from other UEs, in the target cell. According to certain embodiments, for example, the UE ID may include any identifier that uniquely identifies a UE within the target cell. As such, the terms UE ID and unique UE ID may be used interchangeably herein. In a particular embodiment, the UE ID is something other than a C-RNTI since multiple UEs can share a C-RNTI. However, it is recognized that in a small area, the C-RNTI might not be reused so it may be used to uniquely identify the UE. In yet another embodiment, the UE ID may include a C-RNTI and something else.

In a particular embodiment, based on the UE ID, the target network node 106 determines the configuration for the first UE 104. The target network node 106 further determines that the required resource of the configuration is not being used by any other UE in the target cell.

In a particular embodiment, the target network node 106 stores a mapping of the UE ID to the configuration.

In a particular embodiment, the required resource comprises a resource that is not shareable with any other UE served by the target network node 106 in the target cell.

In a particular embodiment, based on none of the required resources of the configuration being allocated to another UE in the target cell, the second message indicates that all required resources associated with the configuration are to be activated.

In a particular embodiment, based on at least one other required resource of the configuration having been allocated to another UE in the target cell, the second message indicates at least one other required resource of the configuration that is not to be activated.

In a particular embodiment, the target network node 106 determines that the at least one other required resource of the configuration is used by a second UE in the target cell.

In a particular embodiment, the target network node 106 transmits, to the first UE 104, an updated configuration for the at least one other required resource.

In a particular embodiment, the required resource includes one or more of a C-RNTI, a CS-RNTI, a PUCCH resource, a preamble for Random Access, a CFRA resource; a CG resource; and an SRS.

In a particular embodiment, the first message comprises a RRCReconfigurationComplete message.

In a particular embodiment, the first message comprises a C-RNTI that is different from the UE ID.

In a particular embodiment, the second message is transmitted via at least one of: DCI, a Random Access Response message, and a MSG 4 of a Random Access procedure.

In a particular embodiment, prior to an initiation of a conditional handover of the first UE, the target network node 106 transmits, to a source network node 110 serving the first UE 104, the configuration comprising the required resource for use in the target cell.

In a particular embodiment, a target area comprises a plurality of target cells, and the configuration comprises a plurality of sub-configurations. Each sub-configuration is for a respective one of the plurality of target cells in the target area.

In a further particular embodiment, each sub-configuration for a respective one of the plurality of target cells is received from a respective one of a plurality of target network nodes prior to the execution of the conditional handover.

In a further particular embodiment, each sub-configuration comprises a required resource for use in a respective one of the plurality of target cells.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information, or converted information, to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1.-34. (canceled)

35. A method by a target network node associated with a target cell, the method comprising:
receiving, from a first User Equipment, UE, a first message indicating a UE identifier, UE ID, of the first UE, the UE ID being associated with a configuration of resources for the first UE, the resources comprising required resources and further resources;
based on a required resource of the configuration not being allocated to another UE in the target cell, transmitting, to the first UE, a second message indicating to activate the required resource of the configuration for use by the first UE in the target cell.

36. The method of claim 35, wherein the UE ID is unique to the first UE, as distinct from other UEs, in the target cell.

37. The method of claim 35, comprising at least one of:
storing a mapping of the UE ID to the configuration;
based on the UE ID, determining the configuration for the first UE and determining that the required resource of the configuration is not being used by any other UE in the target cell; and
prior to an initiation of a conditional handover of the first UE, transmitting, to a source network node serving the first UE, the configuration comprising the required resource for use in the target cell.

38. The method of claim 35, wherein the required resource comprises a resource that is not shareable with any other UE served by the target network node in the target cell, and/or wherein based on none of the required resources of the configuration being allocated to another UE in the target cell, the second message indicates that all required resources associated with the configuration are to be activated.

39. The method of claim 35, wherein, based on at least one other required resource of the configuration having been allocated to another UE in the target cell, the second message indicates at least one other required resource of the configuration that is not to be activated, optionally the method comprising at least one of:
determining that the at least one other required resource of the configuration is used by a second UE in the target cell; and
transmitting, to the first UE, an updated configuration for the at least one other required resource.

40. The method of claim 35, wherein the required resource comprises:
a Cell-Radio Network Temporary Identifier, C-RNTI;
a Configured Scheduling-Radio Network Temporary Identifier CS-RNTI;
a Physical Uplink Control Channel, PUCCH, resource;
a preamble for Random Access;
a Contention Free Random Access, CFRA, resource;
a Configured Grant, CG, resource; and
a Sounding Reference Signal, SRS.

41. The method of claim 35, wherein the first message comprises a RRCReconfigurationComplete message and/or a C-RNTI that is different from the UE ID.

42. The method of claim 35, wherein the second message is transmitted via at least one of:
Downlink Control Information, DCI;
a Random Access Response message; and
a MSG 4 of a Random Access procedure.

43. The method of claim 35, wherein:
a target area comprises a plurality of target cells,
the configuration comprises a plurality of sub-configurations, and
each sub-configuration being for a respective one of the plurality of target cells in the target area, optionally wherein each sub-configuration for a respective one of the plurality of target cells is received from a respective one of a plurality of target network nodes prior to the execution of the conditional handover and/or optionally wherein each sub-configuration comprises a required resource for use in a respective one of the plurality of target cells.

44. A target network node associated with a target cell, the target network node being configured to:
receive, from a first User Equipment, UE, a first message indicating a UE identifier, UE ID, of the first UE, the UE ID being associated with a configuration of resources for the first UE, the resources comprising required resources and further resources;
based on a required resource of the configuration not being allocated to another UE in the target cell, transmitting, to the first UE, a second message indicating to activate the required resource of the configuration for use by the first UE in the target cell.

45. The target network node of any claim 44, being configured to:
store a mapping of the UE ID to the configuration, and/or
based on the UE ID, determine the configuration associated with the first UE; and
determine that the required resource of the configuration is not being used by any other UE in the target cell.

46. The target network node of claim 44 wherein, based on no required resource of the configuration being allocated to another UE in the target cell, the second message indicates that all required resources associated with the configuration are to be activated, or, wherein, based on at least one other required resource of the configuration having been allocated to another UE in the target cell, the second message indicates the at least one other required resource of the configuration that is not to be activated.

47. The target network node of claim 46, adapted to determine that the at least one other required resource of the configuration is used by a second UE in the target cell.

48. The target network node of claim 46, comprising transmitting, to the first UE, an updated configuration for the at least one other required resource.

49. The target network node of claim 46, wherein the critical resource comprises:
a Cell-Radio Network Temporary Identifier, C-RNTI;
a Configured Scheduling-Radio Network Temporary Identifier CS-RNTI;
a Physical Uplink Control Channel, PUCCH, resource;
a preamble for Random Access;
a Contention Free Random Access, CFRA, resource;
a Configured Grant, CG, resource; and
a Sounding Reference Signal, SRS.

50. The target network node of claim 45, wherein the first message comprises a RRCReconfigurationComplete message and/or a C-RNTI that is different from the unique UE ID.

51. The target network node of claim 45, wherein the second message is transmitted via at least one of:
Downlink Control Information, DCI;
a Random Access Response message; and
a MSG 4 of a Random Access procedure.

52. The method of claim 45, adapted to:
prior to an initiation of a conditional handover of the first UE, transmit, to a source network node serving the first UE, the configuration comprising the required resource for use in the target cell.

53. A method by a User Equipment, UE, the method comprising:
initiating transmission, to a target network node associated with a target cell, of a first message indicating a UE identifier, UE ID, of the UE, the UE ID being associated with a configuration of resources for the UE, the resources comprising required resources and further resources; and
based on a required resource of the configuration not being allocated to another UE in the target cell, receiving, from the target network node, a second message indicating to activate the required resource of the configuration for use by the UE in the target cell.

54. A User Equipment, the User Equipment being configured to:
initiate transmission, to a target network node associated with a target cell, of a first message indicating a UE identifier, UE ID, of the UE, the UE ID being associated with a configuration of resources for the UE, the resources comprising required resources and further resources; and
based on a required resource of the configuration not being allocated to another UE in the target cell, receive, from the target network node, a second message indicating to activate the required resource of the configuration for use by the UE in the target cell.
